(19) United States
(12) Patent Application Publication
(10) Pub. No.: US 2015/0189395 A1
(43) Pub. Date: Jul. 2, 2015

(54) SYSTEMS AND METHODS FOR COMMUNICATING AND VALIDATING ADCOPY INSTRUCTIONS

(71) Applicant: COX COMMUNICATIONS, INC., ATLANTA, GA (US)

(72) Inventors: Dan Garvel, Atlanta, GA (US); Sandra Ashburn, Atlanta, GA (US); Ann-Marie Dougherty, Atlanta, GA (US); Shawn Coffman, Atlanta, GA (US)

(73) Assignee: COX COMMUNICATIONS, INC., ATLANTA, GA (US)

(21) Appl. No.: 14/145,411

(22) Filed: Dec. 31, 2013

(51) Int. Cl. H04N 21/81; H04N 21/475; H04N 21/231; H04N 21/2547; G06Q 10/10; H04N 21/235

(52) U.S. Cl. CPC H04N 21/812; G06Q 10/103; H04N 21/235; H04N 21/23109; H04N 21/2547; H04N 21/4753

(57) ABSTRACT

Embodiments disclosed herein relate to a system and method for validating adcopy instructions. A user selection of an advertising client may be received. One or more advertising orders associated with the advertising client are identified in an order management system. A selection of an advertising order is received from the user. A set of adcopy instructions to be associated with the selected advertising contract is received from the user. The set of adcopy instructions are validated based on one or more rules associated with each of the order management system and a traffic and billing system. When the adcopy instructions are validated, the adcopy instructions are stored in a database associated with the traffic and billing system.

### TECHNICAL FIELD

Embodiments of this disclosure relate generally to systems and methods for validating and communicating adcopy instructions.

### BACKGROUND

Today, a television provider, such as a cable network, may use separate order management systems and traffic and billing systems to successfully present an advertisement ordered by a client at one or more requested time(s), on one or more requested network(s), and in one or more requested zone(s). However, advertising orders may not include all of the adcopy information the cable network requires to successfully present the requested advertisement. Order information and adcopy information may be entered into different systems, at different times, by different users, and in accordance with different business rules and requirements which may create errors or inconsistencies between the data in each system.

### BRIEF DESCRIPTION OF THE FIGURES

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a block diagram of an example advertising system, in accordance with one or more embodiments of the disclosure.

FIG. 2 depicts a flow diagram of a method for entering advertising copy instructions and reconciling advertising copy instructions in an advertising billing system and an advertising traffic system, in accordance with one or more embodiments of the disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers refer to like elements throughout.

### DETAILED DESCRIPTION

Embodiments of the disclosure now will be described more fully hereinafter with reference to the accompanying drawings, in which embodiments of the disclosure are shown. This disclosure may, however, be embodied in many different forms and should not be construed as limited to the embodiments set forth herein; rather these embodiments are provided so that this disclosure will be thorough and complete, and will fully convey the scope of the disclosure to those skilled in the art. Like numbers refer to like elements throughout.

Certain embodiments herein may be directed to providing systems and methods communicating and validating adcopy instructions. In some example implementations, a user may utilize valid login credentials to access at least an adcopy wizard system which may be in communication with an order management system and traffic and billing system. In one example, the user may select an advertising client which may include, but is not limited to, a corporation, a partnership, or an individual purchasing or attempting to purchase an advertising spot. The user may enter lookup criteria to search for a particular client or order. For example, the user may enter an advertising order number, a client or agency name, a client identifier, a particular database, or a market. Based on the user's criteria, the adcopy wizard system may search for matching clients and present a list of candidates to the user. The user may then select a particular client in the list. One or more advertising orders associated with the selected advertising client may be identified. For example, active advertising orders for a particular client name or client identifier may be identified and displayed to a user. The user may select the advertising order for which he or she wishes to enter or access associated adcopy instructions from the order management system database. Adcopy instructions are entered by the user and/or accessed by the user. For example, the user may enter adcopy instruction information associated with the selected advertising order or the user may access adcopy instructions stored in the traffic and billing database. The adcopy instructions may include, without limitation, client information (i.e., client number and name), spot name and description, spot duration, start date, end date, network (including any network specific restrictions), zone (e.g., city, state, and/or region), price, number of spots and availability. The adcopy wizard system may provide a user interface to allow the user to enter adcopy instruction information. The user interface may present a list of adcopy instruction selections available to the user. Each selection of adcopy instruction information selected may be validated against one or more business rules associated with the order management system and/or the traffic and billing system. In one embodiment, the user interface module of the adcopy wizard system may display a visual indicator to the user informing the user of the progress of the validation process. As each validation step is completed a check may be automatically populated by adcopy wizard system in the validation checklist and visually presented to the user. Following successful validation, the adcopy instructions are submitted to the traffic and billing system.

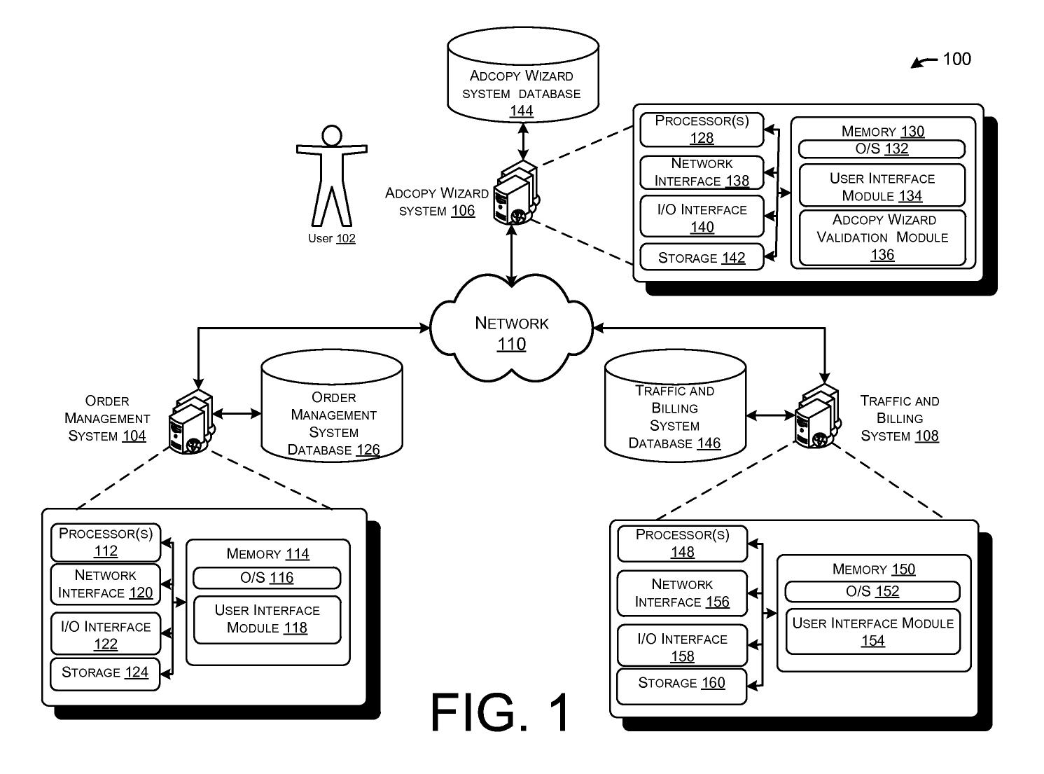

FIG. 1 illustrates an example advertising system 100, in accordance with one or more embodiments of the disclosure. The system 100 of FIG. 1 includes one or more users 102, an order management system 104, an adcopy wizard system 106, and a traffic and billing system 108. The order management system 104, the adcopy wizard system 106, and the traffic and billing system 108 may all be in communication with each other via one or more network(s) 110 which may include one or more independent and/or shared private and/or public networks including the Internet or a publicly switched telephone network. In other example embodiments, one or more components of the system 100 may communicate via direct connections and/or communication links.

Generally, network devices and systems, including the order management system 104, the adcopy wizard system 106, and the traffic and billing system 108 may include or otherwise be associated with suitable hardware and/or software for transmitting and receiving data and/or computer-executable instructions over one or more communication links or networks. These network devices and systems may also include any number of processors for processing data and executing computer-executable instructions, as well as other internal and peripheral components currently known in the art or which may be developed in the future. Further, these network devices and systems may include or be in communication with any number of suitable memory devices operable to store data and/or computer-executable instructions. By executing computer-executable instructions, each of the network devices may form a special-purpose computer or particular machine. As used herein, the term “computer-readable medium” describes any medium for storing computer-executable instructions.

Each of these components—the order management system 104, the adcopy wizard system 106, the traffic and billing system 108, and the network 110—will now be discussed in further detail. Although the components are generally discussed as singular components, as may be implemented in various example embodiments, in alternative exemplary embodiments each component may include any number of suitable computers and/or other components.

With continued reference to FIG. 1, the order management system 104 may be associated with any television provider (i.e., a cable television provider) and may be any type of computing device configured to create, receive, and/or communicate an advertising order within the advertising system 100. For example, the order management system 104 may include, without limitation, one or more computing devices that include any number of server computers, mainframe computers, networked computers, desktop computers, personal computers, mobile devices, smartphones, digital assistants, table devices, Internet appliances, and/or any other processor-based devices.

The order management system 104 may include one or more processors 112, a memory 114 for storing an operating system (O/S), a user interface module 118, a network interface 120, input/output interface(s) 122 and storage 124. The computer processors 112 may computer one or more cores and may be configured to access and execute (at least in part) computer-readable instructions stored in the memory 114. The one or more computer processors 112 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The order management system 104 may also include a chipset (not shown) for controlling communications between the one or more processors 112 and one or more of the other components of the order management system 104. The one or more processors 112 may also include one or more application-specific integrated circuits (ASICs) or application-specific standard products (ASSPs) for handling specific data processing functions or tasks. In one non-limiting example, the computer-executable instructions may be operable for facilitating the creation of an advertising order during an advertising ordering process. In one non-limiting example, the advertising order may include, without limitation, client information (i.e., a client name, a client ID, etc.), one or more zones (i.e., geographical areas within the country or a specific region within the country) the client would like the advertisement to run within, one or more networks (i.e., NBC, ABC, ESPN, etc.) the client would like the advertisement to run on, a cost associated with the advertising order, how many advertising spots the client would like to run, and/or the like. While the advertising order is described to include information associated with a single advertisement, it is to be appreciated that the advertising order may include an order for multiple advertisements. For example, the advertising order may include a first advertisement requesting to run in the northwest on all NBC affiliates. The advertising order may also include a second order requesting to run in the northeast on all ESPN channels.

The memory 114 may comprise one or more computer-readable storage media (CRSM). In some embodiments, the memory 114 may include non-transitory media such as random access memory (RAM), flash RAM, magnetic media, read-only memory (ROM), optical media (e.g., CD-ROM, DVD-ROM, BD-ROM), erasable programmable ROM (EPROM), electrically EPROM (EEPROM), solid-state media, and so forth. The memory 114 may be volatile (in that information is retained while providing power) or non-volatile (in that information is retained without providing power). Additional embodiments may also be provided as a computer program product including a non-transitory machine-readable signal (in compressed or uncompressed form). Examples of machine-readable signals include, but are not limited to, signals carried by the Internet or other networks. For example, distribution of software via the Internet may include a non-transitory machine-readable signal. Additionally, the memory 114 may store an operating system 116 that includes a plurality of computer-executable instructions that may be implemented by the computer processor 112 to perform a variety of tasks to operate the interface(s) and any other hardware installed on the order management system 104. The memory 114 may also store content that may be displayed by the order management system 104 or transferred to other devices (for example, headphones) to be displayed or played by the other devices. The memory 114 may also store content received from the other devices. The content from the other devices may be displayed, played, or used by the order management system 104 to perform any necessary tasks and/or operations that may be implemented by the computer processor 112 or other components in the order management system 104.

In addition, the memory 114 may store the user interface module 118. The user interface module 118 may include one or more computer-executable instructions that may be executed by the computer processor 112. For example, the user interface module 118 may permit one or more users 102 to enter one or more advertising orders. In one example, the user 102 may be an employee, such as a television provider sales staff member, a customer service staff member, or the like. The user interface module 118 may further permit the use 102 to store the entered advertising order in the order management system database 126, which may be a relational or a non-relational database.

The network interface 120 may comprise one or more communication interfaces or network interface devices to provide for the transfer of data between the order management system 104 and another device (e.g., the wizard system 106, traffic and billing system 108, etc.) via a network, such as network 110. The communication interfaces may include, but are not limited to: personal area networks (PANs), wired local area networks (LANs), wireless local area networks (WLANs), wireless wide area networks (WWANs), and so forth. The order management system 104 may be coupled to the network 110 via a wired or wireless connection.

The order management system 104 also includes one or more input/output interfaces 122. The input/output interfaces 122 may provide connectivity to an input device, such as a keyboard, a numeric pad, a mouse, a trackball, one or more electromechanical buttons, or another input device. Further, the input/output interfaces 122 may provide connectivity to an output device, such as a display device, a printer device, or other output device. The input/output interfaces 122 may also provide connectivity to the order management system database 126.

With continued reference to FIG. 1, the adcopy wizard system 106 may be associated with a cable television provider to assist in entry of adcopy instructions into the traffic and billing system 108. The adcopy wizard system 106 may also assist in the validation of the entered adcopy instructions. The adcopy wizard system 106 may include one or more processors 128, a memory 130 storing an operating system (O/S) 132, a user interface module 134, an adcopy wizard validation module 136, a network interface 138, an input/output (I/O) interface(s) 140, and storage 142. In one embodiment, the adcopy wizard system 106 may be a desktop computer, a server device, a collection of servers (e.g., a server cloud), or any other similar device or system.

The computer processors 128 may comprise one or more cores and may be configured to access and execute (at least in part) computer-readable instructions stored in the memory 130. The one or more computer processors 128 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The adcopy wizard system 106 may also include a chipset (not shown) for controlling communications between the one or more processors 128 and one or more of the other components of the adcopy wizard system 106. The one or more processors 128 may also include one or more application-specific integrated circuits (ASICs) or application-specific standard products (ASSPs) for handling specific data processing functions or tasks.

The memory 130 may comprise one or more computer-readable storage media (CRSM). In some embodiments, the memory 130 may include non-transitory media such as random access memory (RAM), flash RAM, magnetic media, read-only memory (ROM), optical media (e.g., CD-ROM, DVD-ROM, BD-ROM), erasable programmable ROM (EPROM), electrically EPROM (EEPROM), solid-state media, and so forth. The memory 130 may be volatile (in that information is retained while providing power) or non-volatile (in that information is retained without providing power). Additional embodiments may also be provided as a computer program product including a non-transitory machine-readable signal (in compressed or uncompressed form). Examples of machine-readable signals include, but are not limited to, signals carried by the Internet or other networks. For example, distribution of software via the Internet may include a non-transitory machine-readable signal. Additionally, the memory 130 may store an operating system 132 that includes a plurality of computer-executable instructions that may be implemented by the computer processor 128 to perform a variety of tasks to operate the interface(s) and any other hardware installed on the adcopy wizard system 106. The memory 130 may also store content that may be displayed by the adcopy wizard system 106 or transferred to other devices (for example, headphones) to be displayed or played by the other devices. The memory 130 may also store content received from the other devices. The content from the other devices may be displayed, played, or used by the adcopy wizard system 106 to perform any necessary tasks or operations that may be implemented by the computer processor 128 or other components in the adcopy wizard system 106.

The memory 130 also may store a user interface module 134 that includes a plurality of computer-executable instructions that may be executed by the processor 128 to perform a variety of tasks, as will be further explained below. For example, user interface module 134 may provide a user interface to allow one or more users to enter adcopy instructions or edit already existing adcopy instructions. The adcopy instructions may include, without limitation, a spot name, a spot identification, a duration of an advertisement, one or more channel or network assignments, one or more day and/or time restrictions, and/or the like. The memory 130 may further store the adcopy wizard validation module 136. In one non-limiting example, the adcopy wizard validation module 136 may validate adcopy instructions (i.e., the spot name, the spot identification, the duration of an advertisement, the one or more channel or network assignments, the one or more day and/or time restrictions, and/or the like) entered by the user 102. In one example, the user entering the information into the order management system 104 may be the same user entering the adcopy instructions and/or accessing already adcopy instructions. Alternatively, the user entering the information into the order management system 102 may be a different user then the user entering the adcopy instruction and/or accessing already adcopy instruction information. The adcopy wizard validation module 136 may validate the entered and/or edited adcopy instruction information entered by the user. For example, the adcopy wizard validation module 136 may compare the entered and/or edited adcopy instruction information against one or more business rules and/or requirements received and/or accessed from the order management system 104 and/or from the traffic and billing system 108.

The network interface 138 may comprise one or more communication interfaces or network interface devices to provide for the transfer of data between the adcopy wizard system 106 and another device (e.g., order management system 104 or traffic and billing system 108) via a network, such as network 110. The communication interfaces may include, but are not limited to: personal area networks (PANs), wired local area networks (LANs), wireless local area networks (WLANs), wireless wide area networks (WWANs), and so forth. The adcopy wizard system 106 may be coupled to the network 110 via a wired or wireless connection.

The wizard system 106 also includes one or more input/output interfaces 140. The input/output interfaces 140 may provide connectivity to an input device, such as a keyboard, a numeric pad, a mouse, a trackball, one or more electromechanical buttons, a camera that detects gestures, or another input device. Further, the input/output interfaces 140 may provide connectivity to an output device, such as a display device, a printer device, or other output device. The input/output interfaces 140 may also provide connectivity to an adcopy wizard system database 144, which may be a relational or non-relational database. The adcopy wizard system database 144 may be configured to temporarily store information utilized during the validation process. For example, the adcopy wizard system database 144 may store information related to accessed information in the order management system 104 (i.e., advertising order information and/or business rules associated with the order management system 104) and/or information related to entered, edited, and or accessed adcopy instruction information from the traffic and billing system 108 (i.e., already entered adcopy information and/or business rules associated with the traffic and billing system 108).

With continued reference to FIG. 1, the traffic and billing system 108 may include advertisement copy instructions (adcopy instructions) utilized by the advertisement system 100 during a providers billing and scheduling processes. Such instructions may include an identification of advertisement copy, a description of the advertisement copy, a length of the advertisement copy, an internal identification of the advertisement copy, a tape identification, a start date, an end date, a rotation amount, and/or notes related to the advertisement copy. The traffic and billing system 108 may be any type of computing device configured to execute traffic and billing software. For example, in one embodiment, the traffic and billing system 108 may be a desktop computer, a server device, a collection of server devices (e.g., a server cloud), or any other similar device or system. The traffic and billing system 108 may be coupled to or connected to a traffic and billing system database 146. The traffic and billing system 108 may include one or more processors 148, a memory 150 storing an operating system (O/S) 152, a user interface module 154, a network interface 156, an input/output (I/O) interface(s) 156, and storage 158.

The computer processors 148 may comprise one or more cores and may be configured to access and execute (at least in part) computer-readable instructions stored in the memory 150. The one or more computer processors 148 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The traffic and billing system 108 may also include a chipset (not shown) for controlling communications between the one or more processors 148 and one or more of the other components of the traffic and billing system 108. The one or more processors 130 may also include one or more application-specific integrated circuits (ASICs) or application-specific standard products (ASSPs) for handling specific data processing functions or tasks.

The memory 150 may comprise one or more computer-readable storage media (CRSM). In some embodiments, the memory 150 may include non-transitory media such as random access memory (RAM), flash RAM, magnetic media, read-only memory (ROM), optical media (e.g., CD-ROM, DVD-ROM, BD-ROM), erasable programmable ROM (EPROM), electrically EPROM (EEPROM), solid-state media, and so forth. The memory 150 may be volatile (in that information is retained while providing power) or non-volatile (in that information is retained without providing power). Additional embodiments may also be provided as a computer program product including a non-transitory machine-readable signal (in compressed or uncompressed form). Examples of machine-readable signals include, but are not limited to, signals carried by the Internet or other networks. For example, distribution of software via the Internet may include a non-transitory machine-readable signal. Additionally, the memory 150 may store an operating system 152 that includes a plurality of computer-executable instructions that may be implemented by the computer processor 148 to perform a variety of tasks to operate the interface(s) and any other hardware installed on the traffic and billing system 108. The memory 150 may also store content that may be displayed by the traffic and billing system 108 or transferred to other devices (for example, headphones) to be displayed or played by the other devices. The memory 150 may also store content received from the other devices. The content from the other devices may be displayed, played, or used by the traffic and billing system 108 to perform any necessary tasks or operations that may be implemented by the computer processor 130 or other components in the traffic and billing system 108.

The network interface 158 may comprise one or more communication interfaces or network interface devices to provide for the transfer of data between the traffic and billing system 108 and another device (e.g., order management system 104 or wizard system 106) via a network, such as network 110. The communication interfaces may include, but are not limited to: personal area networks (PANs), wired local area networks (LANs), wireless local area networks (WLANs), wireless wide area networks (WWANs), and so forth. The traffic and billing system 108 may be coupled to the network 110 via a wired or wireless connection.

The traffic and billing system 108 also includes one or more input/output interfaces 160. The input/output interfaces 160 may provide connectivity to an input device, such as a keyboard, a numeric pad, a mouse, a trackball, one or more electromechanical buttons, a camera that detects gestures, or another input device. Further, the input/output interfaces 160 may provide connectivity to an output device, such as a display device, a printer device, or other output device. The input/output interface 158 may also provide connectivity to the traffic and billing system database 146. The traffic and billing system database 146 may store information including, without information, one or more traffic and billing system business rules, adcopy information, and/or the like.

The traffic and billing system 108 may also store in the traffic and billing system database 146 details and other data related to adcopy. Such information may include a client name, client identification, address information, contract line information, advertisement copy groups, advertisement library information, advertisement group patterns, and/or other such data. Advertisement library information may include an identification of advertisement copy, a spot name, a local identifier, a length, a start date, a start time, a stop date, a stop time, a day start time, a day stop time, a spot identifier, and a status.

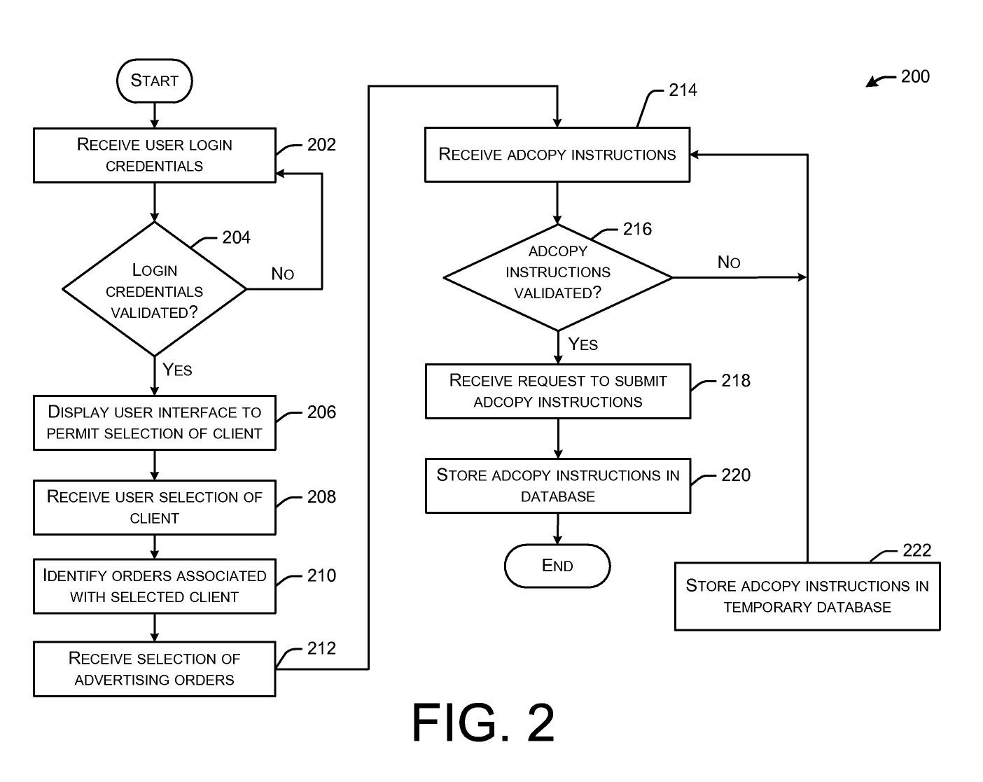

FIG. 2 illustrates a flow diagram of a method 200 for reconciling adcopy instructions in an advertising system, according to one or more embodiments disclosed herein.

Method 200 may be implemented, in one embodiment, by the user interface module 138 of the adcopy wizard system 106 of FIG. 1. For example, the user interface module 138 may provide an interface for a user to select an advertising order and to enter, edit, and or access adcopy instructions, as described herein.

At block 202, login credentials are received from one or more user(s) 102. The login credentials may be, in one embodiment, a user name and password. The user name and password may provide access to one or more of the order management system 104, the traffic and billing system 108, or may be unique to the adcopy wizard system 106.

At decision block 204, the login credentials are validated and a determination is made as to whether the login credentials correspond to a valid user account. In one embodiment, the login credentials are validated against a Lightweight Directory Access Protocol (LDAP) authentication server. If the login credentials do not correspond to a valid user account, the method 200 may return to block 202, where the user may enter another set of login credentials. If the login credentials do correspond to a valid user account, the method 200 proceeds to block 206, where a user interface is displayed to permit selection of an advertising client. An advertising client, for example may be a corporation, a partnership, or an individual purchasing or attempting to purchase an advertising spot. Additionally, if the login credentials do correspond to a valid user account, session variables for the adcopy wizard system 106 may be initiated and set.

At block 208, a selection of an advertising client is received from the user. In one embodiment, the user may enter lookup criteria to search for a particular client or order. For example, the user may enter an advertising order number, a client or agency name, a client identifier, a particular database, or a market. Based on the user's criteria, the adcopy wizard system 106 may search for matching clients and present a list of candidates to the user. The user may then select a particular client in the list.

At block 210, one or more advertising orders associated with the selected advertising client are identified. For example, active advertising orders for a particular client name or client identifier may be identified and displayed to a user. The advertising order may include, without limitation, client information (i.e., client number and name), start date, end date, zone (e.g., city, state, and/or region), channel and/or network, price, and number of spots.

At block 212, a selection of an advertising order associated with the user's selected advertising client is received. The user may select the advertising order for which he or she wishes to enter or access associated adcopy instructions. The advertising order may be selected from one or more advertising orders stored in the order management system database 126.

At block 214, a set of adcopy instructions are entered by the user and/or accessed by the user. For example, the user may enter adcopy instruction information associated with the selected advertising order or the user may access adcopy instructions stored in the traffic and billing database 146. The adcopy instructions accessed by the user may be edited by the user if necessary. The adcopy instructions may include, without limitation, client information (i.e., client number and name), spot name and description, spot duration, start date, end date, network (including any network specific restrictions), zone (e.g., city, state, and/or region), price, number of spots and availability.

In one embodiment, the adcopy wizard system 106 may provide a user interface (i.e., user interface 134) to allow the user to enter adcopy instruction information. The user interface may present a list of adcopy instruction selections available to the user. In one embodiment, the adcopy instructions may be categorized by groups. For example, the adcopy instructions may include a zone group, a network group, an available time group, etc. By way of example, the user may be presented with a group corresponding to the zone adcopy instruction. The zone group may include, at least, a list of potential zones available for selection. Once the user selects a zone, one or more available networks within that zone may appear for selection by the user (i.e., an available network group). Then, once a network is selected, the user may be presented with an available times group comprising a list of available times to be associated with the selected advertising order. This process may continue for the remaining adcopy instruction options. Once the user selects the adcopy instructions from each group, the method 200 proceeds to block 216.

The user interface (i.e., user interface 134) may also allow the user to edit already existing adcopy instructions. For example, the user may access adcopy instructions stored in the traffic and billing system database 146. The user interface may present a list of adcopy instructions selections available to the user to edit the already existing adcopy information where necessary.

At decision block 216, each selection of adcopy instruction information selected may be validated against one or more business rules associated with the order management system 104 and the traffic and billing system 108. For example, the adcopy wizard validation module 136 may access one or more business rules stored in the order management system database 126 and one or more business rules stored in the traffic and billing system database 146 to validate each component of the adcopy instruction information as it is selected. Utilizing the accessed business rules, the adcopy wizard validation module 136 may determine whether the selected adcopy information has at least one group with a start date that matches the start date of the selected advertising order, and at least one group with an end date that matches the selected advertising order end date. Further, validation may include a determination that all zones and networks are accounted for, and that the length of the advertising copy group matches the length of the selected contract. Validation may also include a determination that no duplicate networks and duplicate spots are in the adcopy instruction. Finally, validation may include a determination that both the billing system and the traffic system requirements are satisfied by the adcopy instruction.

In one embodiment, the user interface module 134 of the adcopy wizard system 106 may display a visual indicator to the user informing the user of the progress of the validation process. For example, the user interface module may present a validation checklist to the user 102. The validation checklist may include, without limitation, a validation check field, an adcopy instruction field, and an adcopy instruction description field. By way of example only, an illustrative validation checklist may be illustrated in Table 1.

As each validation step is completed a check may be automatically populated by adcopy wizard system 108 in the validation checklist and visually presented to the user. For example, upon completion of the validation of the date, zone and network groups, the adcopy wizard system 108 may populate the validation check field of the validation checklist, illustrated in Table 2.

If the adcopy instruction information is successfully validated at decision block 216, the method 200 proceeds to block 218. At block 218, a request to submit the adcopy instruction is received from the user. Submitting the adcopy instruction may include creating adcopy instructions in the traffic and billing system 108, creating adcopy groups in the traffic and billing system 108, assigning instructions to the adcopy groups in the traffic and billing system 108, assigning groups to order lines in the traffic and billing system 108, and updating an adcopy instruction to accepted in the advertising billing system. The method 200 then proceeds to block 220, where the adcopy instructions are stored in traffic and system database 146 associated with the traffic and billing system 108.

If the adcopy instructions are not successfully validated at decision block 216, the method 200 proceeds to block 222. At block 222, the adcopy instructions may be stored in a temporary database, for example, the adcopy wizard database 144. Additionally, an error message may be displayed to the user. The error message may inform the user of which adcopy instructions did not pass validation, so that the user can then correct the offending instructions and resubmit the adcopy instructions. The method 200 may then return to block 214, where the user can adjust the adcopy instructions, and attempt validation again.

In one embodiment, the user may be provided with an option to store a partial set of adcopy instructions. Such an option may store the partial set of ad copy instructions in the traffic and billing system database 146, for example. For example, the user may enter a subset of the data required for the adcopy instructions, such as a zone and network instruction, but may not have a time instruction. Accordingly, the user may save the zone and network instruction, and later enter the time instruction and validate the adcopy instructions. Such a feature avoids re-entry of partial adcopy instructions.

In one embodiment, the user may be provided with a status page or view which lists partial sets of adcopy instructions. The user may select a partial set in the status page to complete. The status page or view may also display previously completed and submitted adcopy instructions for the user's reference.

Certain aspects of the disclosure are described above with reference to block and flow diagrams of systems, methods, apparatus, and/or computer program products according to example embodiments. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, certain embodiments may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer-implemented method, comprising:
receiving, by a computer system comprising one or more processors, from a user, a selection of an advertising client;
identifying, by the computer system, one or more advertising orders associated with the selected advertising client;
receiving, by the computer system, from the user, a selection of an advertising order associated with the selected advertising client;
receiving, by the computer system, from the user, a set of adcopy instructions, wherein the ad instructions are to be associated with the selected advertising order;
validating, by the computer system, the set of adcopy instructions based on one or more rules associated with each of an order management system and a traffic and billing system; and
storing, by the computer system, in a database associated with the traffic and billing system, the set of adcopy instructions when the adcopy instructions are validated.

2. The computer-implemented method of claim 1, further comprising:
receiving, from the user, login credentials;
determining that the login credentials correspond to a valid user account; and
displaying a user interface to permit a selection of an advertising client.

3. The computer-implemented method of claim 1, wherein the adcopy instructions include at least one of a zone instruction or a network instruction.

4. The computer-implemented method of claim 1, further comprising:
storing, in a temporary database, the adcopy instructions when the adcopy instructions are not successfully validated; and
displaying an error message to the user.

5. The computer-implemented method of claim 1, further comprising:
receiving, from the user, a request to store a partial set of adcopy instructions; and
storing, in a temporary database, the partial set of adcopy instructions, wherein the partial set of adcopy instructions is associated with the selected advertising order in the temporary database.

6. The computer-implemented method of claim 5, further comprising:
receiving, from the user, a request to view a partial set of adcopy instructions.

7. The computer-implemented method of claim 1, wherein receiving a user selection of an advertising client further includes:
receiving one or more elements of advertising client data, the advertising client data including at least one of an order number, contract number, advertising client name, market, or database;
retrieving, from the order management system, one or more advertising clients based on the received advertising client data; and
displaying, to the user, the one or more retrieved advertising clients.

8. An ad copy validation system, comprising:
at least one memory that stores computer-executable instructions; and
at least one processor configured to access the at least one memory, wherein the at least one processor is configured to execute the computer-executable instructions to:
receive, from a user, a selection of an advertising client;
identify, in an order management system, one or more advertising orders associated with the selected advertising client;
receive, from the user, a selection of an advertising order associated with the selected advertising client;
receive, from the user, a set of adcopy instructions, wherein the adcopy instructions are to be associated with the selected advertising order;
validate the set of adcopy instructions based on one or more rules associated with each of the order management system and a traffic and billing system; and
store, in a billing and traffic database associated with the traffic and billing system, the set of adcopy instructions when the adcopy instructions are validated.

9. The system of claim 8, the at least one processor further configured to execute the computer-executable instructions to:
receive, from the user, login credentials;
determine that the login credentials correspond to a valid user account; and
display a user interface to permit a selection of an advertising client.

10. The system of claim 8, wherein the adcopy instructions include least one of a zone instruction or a network instruction.

11. The system of claim 8, the at least one processor further configured to execute the computer-executable instructions to:
store, in a temporary database, the adcopy instructions when the adcopy instructions are not successfully validated; and
display an error message to the user.

12. The system of claim 8, the at least one processor further configured to execute the computer-executable instructions to:
receive, from the user, a request to store a partial set of adcopy instructions; and
store, in a temporary database, the partial set of adcopy instructions, wherein the partial set of adcopy instructions is associated with the selected advertising order in the temporary database.

13. The system of claim 8, the at least one processor further configured to execute the computer-executable instructions to receive, from the user, a request to view a partial set of adcopy instructions.

14. The system of claim 8, wherein receiving the user selection of the advertising client further includes:
receiving one or more elements of advertising client data, the advertising client data including at least one of an order number, contract number, advertising client name, market, or database;
retrieving, from the order management system, one or more advertising clients based on the received advertising client data; and
displaying, to the user, the one or more retrieved advertising clients.

15. A computer program product comprising a computer-readable medium having computer-executable instructions embodied therein, the computer-executable instructions when executed by at least one processor perform the operations comprising:
receiving, from a user, a selection of an advertising client;
identifying, in an order management system, one or more advertising orders associated with the selected advertising client;
receiving, from the user, a selection of an advertising orders associated with the selected advertising client;
receiving, from the user, a set of adcopy instructions, wherein the adcopy instructions are to be associated with the selected advertising order;
validating the set of adcopy instructions based on one or more rules associated with each of the order management system and a traffic and billing system; and
storing, in a billing and traffic database associated with the traffic and billing system, the set of adcopy instructions when the adcopy instructions are validated.

16. The computer program product of claim 15, the computer-executable instructions when executed by the at least one processor further perform the operations comprising:
receiving, from the user, login credentials;
determining that the login credentials correspond to a valid user account; and
displaying a user interface to permit a selection of an advertising client.

17. The computer program product of claim 15, wherein the adcopy instructions include at least one of a zone instruction or a network instruction.

18. The computer program product of claim 15, the computer-executable instructions when executed by the at least one processor further perform the operations comprising:
storing, in a temporary database, the adcopy instructions when the adcopy instructions are not successfully validated; and
displaying an error message to the user.

19. The computer program product of claim 15, the computer-executable instructions when executed by the at least one processor further perform the operations comprising:
receiving, from the user, a request to store a partial set of adcopy instructions; and
storing, in a temporary database, the partial set of adcopy instructions, wherein the partial set of adcopy instructions is associated with the selected advertising order in the temporary database.

20. The computer program product of claim 19, the computer-executable instructions when executed by the at least one processor further perform the operations comprising receiving, from the user, a request to view a partial set of adcopy instructions.
